(19) United States
(12) Patent Application Publication
(10) Pub. No.: US 2018/0329851 A1
(43) Pub. Date: Nov. 15, 2018

(54) USB INTERFACE CIRCUIT AND USB DEVICE

(71) Applicant: MediaTek Singapore Pte. Ltd., Singapore (SG)

(72) Inventors: Yuping Leng, Hefei City, Anhui Prov. (CN); Yau-Wai Wong, Hsinchu County (TW); Yong Wang, Hefei City, Anhui (CN); Yuan Chen, Hefei City, Anhui (CN); Dingjun Xu, Hefei, Anhui (CN); Ming-Feng Lin, Hsinchu City (TW)

(21) Appl. No.: 15/978,200

(22) Filed: May 14, 2018

(30) Foreign Application Priority Data
May 15, 2017 (CN) 201710338428.0

(51) Int. Cl. G06F 13/42

(52) U.S. Cl. CPC G06F 13/42; G06F 2213/0042

(57) ABSTRACT

The present invention provides a USB interface circuit comprising a USB transceiver and at least two USB controllers of different protocol types; wherein at least one USB transceiver is selectively coupled to at least two USB controllers and is controlled by only one of the at least two USB controllers at the same time. The invention also provides a USB device. In the above-described content, the present invention can change the type of the USB interface circuit in the case where the circuit connection relation is determined, so as to improve the flexibility

### BACKGROUND

Universal Serial Bus (USB) is an external bus standard for connecting computer systems and external devices, and is widely used in electronic products such as personal computers and mobile devices.

In general, a USB device includes a master chip, a USB controller, a USB transceiver, and a USB plug/socket. The USB transceiver mainly executes the functions of the physical layer including transmitting and receiving data. The USB controller mainly executes the functions of the protocol layer including encoding, decoding, calibration, and synchronization. The functions of the USB controller can be fewer or added.

The USB devices are categorized into different types depending on the USB interface protocol versions such as USB 2.0, USB 3.0, USB 3.1, and so on. The higher versions of the USB interface are backward compatible, which means that if the higher versions of the USB interface have more lead terminals than the lower version, the higher versions of the USB interface include lead terminals of the lower version of USB interface so as to use a lower version of the transceiver in the higher version interface circuit.

For example, the USB 2.0 plug/socket has four lead terminals, including power supply, ground, and a pair of differential data line lead terminals D+, D−. The USB 2.0 transceiver is coupled to the USB 2.0 plug/socket and the USB 2.0 controller, and used for receiving and transmitting data on the differential data line D+, D−. USB 3.0 is backward compatible with USB 2.0, and in addition to 4 lead terminals of USB 2.0, USB 3.0 further includes 5 lead terminals including a pair of differential transmission data line lead terminals SSTX+, SSTX−, and a pair of differential reception data line lead terminals SSRX+, SSRX−. Correspondingly, the USB 3.0 plug/socket and the USB 3.0 controller are both coupled to two USB transceivers, wherein one is the original USB 2.0 transceiver and the other one is the USB 3.0 transceiver for receiving and transmitting data on the differential transmission data lines SSTX+, SSTX− and receiving data on the differential reception data lines SSRX+, SSRX−.

In the prior art, the type of the USB interface circuit is fixed after the circuit connection relationship is determined, and the flexibility is low, for the connection can not be changed according to different requirements afterwards.

### SUMMARY

In accordance with exemplary embodiments of the present invention, a USB interface circuit and a USB device are proposed to solve the problem of poor flexibility of the USB interface circuit type in the prior art.

According to a first aspect of the present invention, an exemplary USB interface circuit is disclosed. The exemplary USB interface circuit comprises: a plurality of USB transceivers (PHY); and at least two different types of USB controllers (MAC); wherein at least one of the USB transceivers is selectively coupled to the at least two USB controllers, and is controlled only by one of the at least two USB controllers at the same time.

According to a first aspect of the present invention, an exemplary USB device is disclosed. The exemplary USB device comprises: a master chip; a plurality of USB transceivers; a plurality of USB plugs/sockets; and at least two different types of USB controllers; wherein the master chip is coupled to the USB controllers, the USB transceivers are coupled to the USB plugs/sockets, and at least one of the USB transceivers is selectively coupled to at least two of the USB controllers and is controlled only by one of the at least two USB controllers at the same time.

The benefits of the present invention is that the USB transceiver is selectively coupled to at least two USB controllers and is controlled by only one of at least two USB controllers at the same time, and controlling the USB transceiver by selecting a different protocol type of the USB controller so as to change the type of the USB interface circuit in the case where the circuit connection relation is determined, and the flexibility is thus improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a USB interface circuit according to a first embodiment of the present invention.

FIG. 2 is a circuit diagram of a USB interface circuit according to a first embodiment of the present invention.

FIG. 3 is an equivalent circuit diagram of a selection method in the USB interface circuit according to the second embodiment of the present invention.

FIG. 4 is another equivalent circuit diagram of a selection method in the USB interface circuit according to the second embodiment of the present invention.

FIG. 5 is a circuit diagram of a USB device according to a first embodiment of the present invention.

FIG. 6 is a circuit diagram of a USB device according to a second embodiment of the present invention.

### DETAILED DESCRIPTION

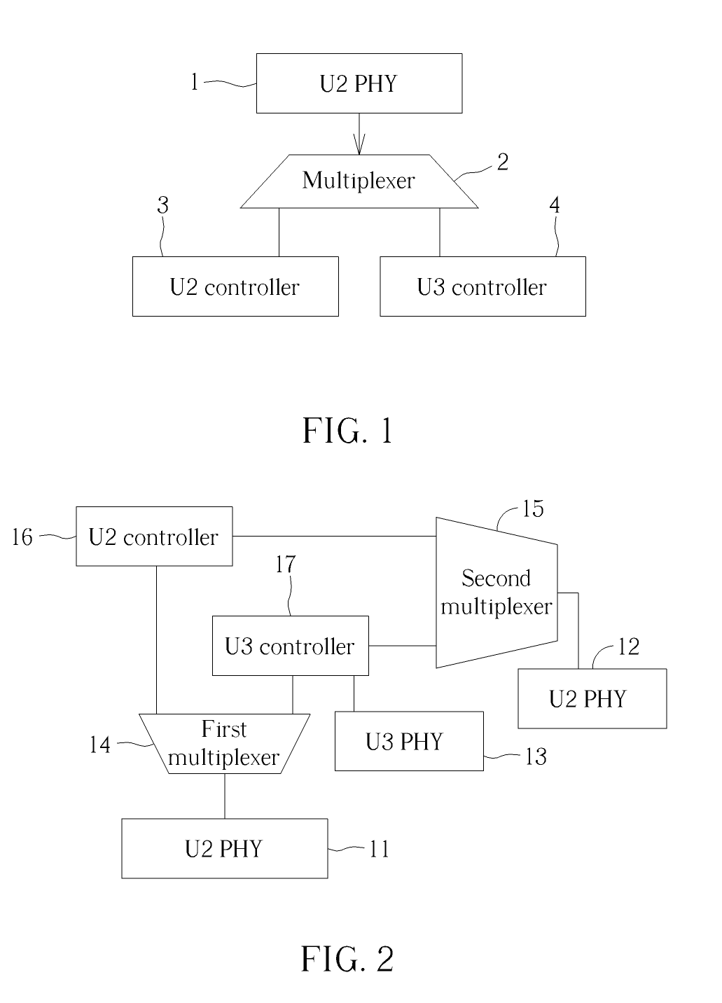

As shown in FIG. 1, the USB interface circuit of the first embodiment in the present invention includes a USB transceiver 1 (shown as “U2 PHY” in FIG. 1), a multiplexer 2, a first USB controller 3 (shown as “U2 controller” in FIG. 1), and a second USB controller 4 (shown as “U3 controller” in FIG. 1).

The USB transceiver 1 is selectively coupled to the first USB controller 3 and the second USB controller 4 through the multiplexer 2. The first USB controller 3 is a USB 2.0 controller that supports USB 2.0 protocol, and the second USB controller 4 is a USB 3.0 controller that supports USB 3.0 protocol. The USB transceiver 1 can be controlled by the first USB controller 3 or the second USB controller 4. Since the USB protocol is backward compatible, the USB transceiver 1 can be a USB 2.0 transceiver that supports USB 2.0 protocol.

The multiplexer 2 employs time divisional multiplexing, that is, the USB transceiver 1 can only be controlled by one of the first USB controller 3 and the second USB controller 4 at the same time. When the USB transceiver 1 is controlled by the first USB controller 3, the USB 2.0 interface circuit is formed. When the USB transceiver 1 is controlled by the second USB controller 4, the second USB controller 4 also needs to be coupled to a USB 3.0 transceiver (not shown) to form a USB 3.0 interface circuit.

The number of the USB transceiver and the USB controller shown in FIG. 1 is only for illustration, and can be increased in actuality. The USB protocol types supported by the USB transceiver and the USB controller described is also for illustration, it only requires that the USB protocol types supported by at least two USB controllers which are coupled to the at least one USB transceiver are different. Of course, in order to make the USB transceiver to normally operate under the control of the USB controller, the USB protocol version of the USB transceiver should not be higher than the USB protocol version of the USB controller coupled to the USB transceiver. In addition to the multiplexer, the USB transceiver can also be coupled to the USB controller via a selector or other forms of circuitry.

With the implementation of the above embodiments, changing the voltage at the address terminal/control terminal of the multiplexer can select a USB controller of different protocol type to control the USB transceiver, which can change the type of the USB interface circuit when the circuit connection relationship is determined, so as to improve flexibility. For example, users can use the U3 controller for high-speed transmission when transmitting large files, and use the U2 controller to save power consumption when transmitting small files.

As shown in FIG. 2, the USB interface circuit of the second embodiment in the present invention includes a USB transceiver 11 (shown as “U2 PHY” in FIG. 2), a second USB transceiver 12 (shown as “U2 PHY” in FIG. 2), a third USB transceiver 13 (shown as “U3 PHY” in FIG. 2), a first multiplexer 14, a second multiplexer 15, a third USB controller 16 (shown as “U2 controller” in FIG. 2), and a fourth USB controller 17 (shown as “U3 controller” in FIG. 2).

The first USB transceiver 11 is selectively coupled to the third USB controller 16 and the fourth USB controller 17 through the first multiplexer 14, and the second USB transceiver 12 is selectively coupled to the third USB controller 16 and the fourth USB controller 17 through the second multiplexer 15. The fourth USB controller 17 is also coupled to the third USB transceiver 13. The first USB transceiver 11 and the second USB transceiver 12 are both USB 2.0 transceivers, and the third USB transceiver 13 is a USB 3.0 transceiver. The third USB controller 16 is a USB 2.0 controller that supports the USB 2.0 protocol, and the four USB controllers 17 is a USB 3.0 controller that supports the USB 3.0 protocol.

In this embodiment, the selection result of the first multiplexer 14 and the second multiplexer 15 is complementary, that is, the third USB controller 16/the fourth USB controller 17 only controls one of the first USB transceiver 11 and the second USB transceiver 12 at the same time. When the first USB transceiver 11 is coupled to the third USB controller 16 through the first multiplexer 14, the second USB transceiver 12 should be coupled to the fourth USB controller 17 through the second multiplex 15, and vice versa.

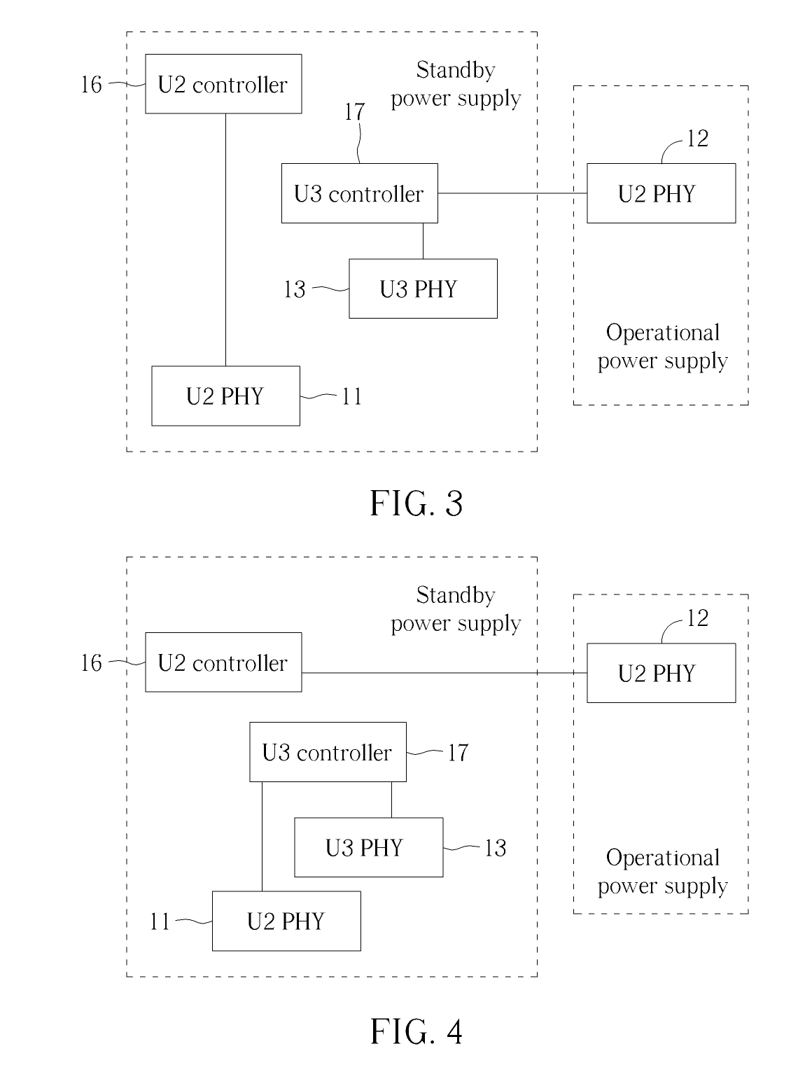

When the first USB transceiver 11 is controlled by the third USB controller 16 and the second USB transceiver 12 is controlled by the fourth USB controller 17, the equivalent circuit diagram is shown in FIG. 3. The second USB transceiver 12 uses an operational power supply. The first USB transceiver 11, the third USB transceiver 13, the first multiplexer 14, the second multiplexer 15, the third USB controller 16, and the fourth USB controller 17 use a standby power supply. The first USB transceiver 11 and the third USB controller 16 form a USB 2.0 interface circuit and it can operate while standby. The second USB transceiver 12, the third USB transceiver 13, and the fourth USB controller 17 forma USB 3.0 interface circuit and it cannot operate while standby.

When the first USB transceiver 11 is controlled by the fourth USB controller 17 and the second USB transceiver 12 is controlled by the third USB controller 16, the equivalent circuit diagram is shown in FIG. 4. The second USB transceiver 12 uses a operational power supply. The first USB transceiver 11, the third USB transceiver 13, the first multiplexer 14, the second multiplexer 15, the third USB controller 16, and the fourth The USB controller 17 use a standby power supply. The first USB transceiver 11, the third USB transceiver 13, and the fourth USB controller 17 form a USB 3.0 interface circuit and it can operate while standby, the second USB transceiver 12 and the third USB controller 16 form a USB 2.0 interface circuit and it cannot operate while standby.

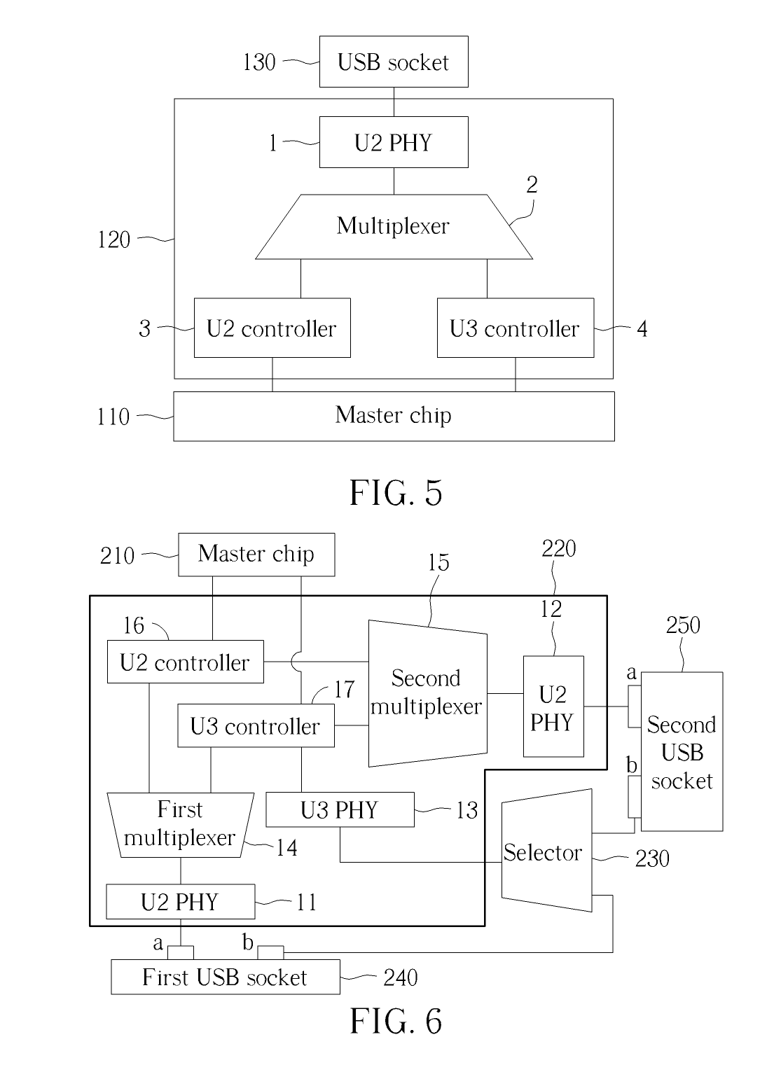

As shown in FIG. 5, a USB device of the first embodiment in the present invention comprises a master chip 110, a USB interface circuit 120, and a USB socket 130. The USB interface circuit 120 is the interface circuit in the first embodiment of the USB interface circuit of the present invention. The master chip 110 is coupled to the first USB controller 3 and the second USB controller 4 in the USB interface circuit 120. The USB socket 130 is coupled to the USB transceiver 1 in the USB interface circuit 120 and the type of the USB receptacle 130 matches the type of the USB interface circuit 120, that is, the supported version of the USB socket 130 is not less than that of the USB interface circuit 120. If the USB transceiver 1 is controlled by the second USB controller 4 and the USB device is a USB 3.0 device, the USB socket 130 should also be coupled to a USB 3.0 transceiver not shown in FIG. 5.

The USB socket can be replaced by a USB plug. In addition, the number of USB transceivers and USB controllers in the USB interface circuit is for illustration, and can be increased in actuality. For example, the USB interface circuit can be replaced by the USB interface circuit in FIG. 2. The USB protocol types of the USB transceiver and the USB controller are also for illustration. The USB transceiver can also be coupled to the USB controller via a selector. It should be noted that the master chip is coupled to all the USB controllers in the USB interface circuit, and the number of USB plugs/sockets can be greater than one, wherein the protocol version of each USB plug/socket and the coupling relationship with the USB transceiver can be determined according to different design requirements.

As shown in FIG. 6, a USB device of the second embodiment in the present invention comprises a master chip 210, a USB interface circuit 220, a selector 230, a first USB socket 240, and a second USB socket 250. The USB interface circuit 220 is the interface circuit in the second embodiment of the USB interface circuit of the present invention, and the master chip 210 is coupled to the third USB controller 16 and the fourth USB controller 17 in the USB interface circuit 220.

In this embodiment, the first USB socket 240 and the second USB socket 250 both support the USB 3.0 protocol, and include two types of lead terminal of a and b, wherein the lead terminal a is a backward compatible low version lead terminal (D+, D− in USB 2.0), and the lead terminal b is a newly added lead terminal of the USB protocol version (SSTX+, SSTX−, SSRX+, SSRX− in USB 3.0) supported by the first USB socket 240 and USB socket 250. The lead terminal a of the first USB socket 240 is coupled to the first USB transceiver 11 in the USB interface circuit 220. The lead terminal a of the second USB socket 250 is coupled to the second USB transceiver 12 in the USB interface circuit 220. The third USB transceiver 13 in the circuit 220 is selectively coupled to the lead terminals b of the first USB socket 240 and the second USB socket 250 through the selector 230.

The selection result of the selector 230 should match the selection result of the first multiplexer 14 and the second multiplexer 15. When the first USB transceiver 11 is controlled by the third USB controller 16 and the second USB transceiver 12 is controlled by the fourth USB controller 17, the third USB transceiver 13 should be coupled to the lead terminal b of the second USB socket 250, and the first USB socket 240 can only operate in USB 2.0 mode while the second USB socket 250 can operate in USB 3.0 mode. When the first USB transceiver 11 is controlled by the fourth USB controller 17 and the second USB transceiver 12 is controlled by the third USB controller 16, the third USB transceiver 13 should be coupled to the lead terminal b of the first USB socket 240, and the first USB socket 240 can operate in USB 3.0 mode while the second USB socket 250 can only operate in USB 2.0 mode.

The number of the USB transceivers, the USB controllers, the USB sockets, and supported protocol types are only for illustrations, and the selector also can be replaced by a multiplexer and the USB socket can be replaced by a USB plug.

With the implementation of the present embodiment, the operation mode of the USB plug/socket can be further changed in the case where the circuit connection relation is determined, and the flexibility can be further improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A USB interface circuit, comprising:
a plurality of USB transceivers (PHY); and
at least two different types of USB controllers (MAC);
wherein at least one of the USB transceivers is selectively coupled to the at least two USB controllers, and is controlled by only one of the at least two USB controllers at the same time.

2. The USB interface circuit of claim 1, wherein at least one of the USB transceivers selectively coupled to the at least two of said USB further comprise: the at least one of the USB transceivers is selectively coupled to the at least two USB controllers through a multiplexer.

3. The USB interface circuit of claim 1, wherein the USB controllers comprises at least a first USB controller supporting USB 2.0 protocol and a second USB controller supporting USB 3.0 protocol.

4. The USB interface circuit of claim 1, wherein the at least one of the USB controllers is coupled to the at least two of the USB transceivers.

5. A USB device, comprising:
a master chip;
a plurality of USB transceivers;
a plurality of USB plugs/sockets; and
at least two USB controllers of different types;
wherein the master chip is coupled to the USB controllers, the USB transceivers are coupled to the USB plugs/sockets, and at least one of the USB transceivers is selectively coupled to the at least two of the USB controllers and is controlled by only one of the at least two USB controllers at the same time.

6. The USB device of claim 5, wherein the at least one of the USB transceivers selectively coupled to the at least two USB controllers further comprises: the at least one of the USB transceivers is selectively coupled to the at least two USB controllers through a multiplexer.

7. The USB device of claim 5, wherein the USB controllers comprises at least a first USB controller supporting USB 2.0 protocol and a second USB controller supporting USB 3.0 protocol.

8. The USB device of claim 5, wherein at least one of the USB transceivers is coupled to the at least two of the USB plugs/sockets.

9. The USB device of claim 8, wherein the USB plugs/sockets comprise two types of lead terminals, one type of lead terminal is a backward compatible lower version lead terminal, and at least one of said USB transceivers is selectively coupled to another type of lead terminal of the at least two of said USB plugs/sockets.

10. The USB interface circuit of claim 5, wherein the at least one of the USB controllers is coupled to the at least two of the USB transceivers.
